(19) United States
(12) Patent Application Publication
(10) Pub. No.: US 2018/0250591 A1
(43) Pub. Date: Sep. 6, 2018

(54) METHODS OF CIRCUMVENTING PLATFORM RESTRICTIONS IN GAMING

(71) Applicant: The Fast Mind, LLC, Plantation, FL (US)

(72) Inventors: Jorge Francisco Prado Rojas, Weston, FL (US); Eddy Jose Prado Rojas, Aventura, FL (US); Lane St. Paul Thompson, Plantation, FL (US); Harry Dessieu, Hollywood, FL (US)

(21) Appl. No.: 15/910,928

(22) Filed: Mar. 2, 2018

Related U.S. Application Data
(60) Provisional application No. 62/465,838, filed on Mar. 2, 2017.

(51) Int. Cl. A63F 13/335; H04L 29/08; G06F 17/30

(52) U.S. Cl. CPC A63F 13/335; G06F 17/30781; H04L 67/02

(57) ABSTRACT

Methods of enabling multiplatform interaction between interactive content applications are contemplated. A message is sent from a first user device to a server, where the message includes an action sequence associated with the interactive content application and, optionally, a video generated by the first user device according to the action sequence running on the native interactive content application. A response is generated by the server based on contents of the message. In some aspects, the server generates a video according to the action sequence to recreate what the action sequence would appear to be if run on the interactive content application. The response can be delivered to the first user device for further distribution or directly to a second user device. Upon clicking a link associated with the response, the second user device can re-engage the action sequence in a web browser without needing to download the interactive content application locally.

This application claims priority to provisional patent application Ser. No. 62/465,838 filed Mar. 2, 2017. All extrinsic materials identified in this application are incorporated by reference in their entirety.

### FIELD OF THE INVENTION

The field of the invention is mobile app technologies.

### BACKGROUND

The background description includes information that may be useful in understanding the present invention. It is not an admission that any of the information provided in this application is prior art or relevant to the presently claimed invention, or that any publication specifically or implicitly referenced is prior art.

Currently, to play a mobile game (e.g., one that is available for download through an app store such as Google Play or Apple's App Store), a user is required to download that game. Once downloaded, a user can then launch and play a game.

A major challenge facing mobile developers is cultivating an active user base. Active users are those users who use an interactive content application, e.g., a game, on a mobile device (or other computing device). One obstacle that would prevent someone from becoming an active user is generally the process of navigating an app store, downloading an app, potentially having to type in a password, and so on, before they can finally play the game.

Some have attempted to create systems that facilitate streaming of a game or app across a network for a remote user. These solutions fail to address issues of latency and the relatively poor user experience associated with streaming solutions, they require both host and client to be operating at the same time, and they also do not qualify a new player as an “active user” since that new player would merely be using a remote instance of a game.

Current systems and methods fail to appreciate advancements that would enable a user to play a mobile game without requiring that user to first install the game on a mobile device. Such a solution would allow a user to become an “active user” of a particular mobile game or app much more easily.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

### SUMMARY OF THE INVENTION

The present invention provides apparatuses, systems, and methods in which multiplatform interaction across interactive content applications is enabled. In one aspect of the inventive subject matter, a method of enabling multiplatform play is contemplated. The method includes the steps of: receiving, by a server, a message from a native interactive content application running on a first user device, where the message comprises a first video of the native interactive content application running on the first user device capturing an action sequence defined by a first user engaging with the interactive content application, and data associated with the action sequence; generating, by the server, a second video comprising at least a portion of the first video; dynamically generating a website, based at least in part on the data associated with the action sequence, wherein the website comprises the second video and enables a second user to engage, through a web browser on a second user device, at least a portion of the action sequence defined by the first user; and sending to the first user device, before or after dynamically generating the website, the second video and a resource locator associated with the website.

It is contemplated that the video can be a looping video, with or without sound. In some embodiments, the looping video is compressed. In some embodiments, when the second user device navigates to the URL with its web browser, the operating system of the second user device or associated identifier is used to select a download link to an installer of the interactive content application corresponding to the operating system.

In another aspect of the inventive subject matter, a computer-implemented method of enabling multiplatform interactive content access is contemplated. The steps include: sending to a server, by a first user device, a message from a native interactive content application running on the first user device, the message comprising a first video of the native interactive content application running on the first user device capturing an action sequence defined by a first user engaging with the interactive content application, and first data associated with the action sequence; receiving a response comprising a resource locator associated with a dynamically generated website, wherein the dynamically generated website displays the first video and enables re-engaging at least a portion of the action sequence defined by the first user through a web-browser-based application; and sending the response to a second user device.

It is contemplated that the video can be a looping video, with or without sound. In some embodiments, the looping video is compressed. In some embodiments, when the second user device navigates to the URL with its web browser, the executable code is run to: (1) determine the operating system of the second user device and display a link to download a version of the game that will run natively on the second device and (2) run the game. In instances where the game being shared is a multiplayer game, it is contemplated that the first user device and the second user device can play the game together cooperatively.

In another aspect of the inventive subject matter, a computer-implemented method of enabling multiplatform interactive content access is contemplated. The method includes the steps of: receiving, by a server, a message from a native interactive content application running on a first user device, wherein the message comprises an action sequence associated with the native interactive content application; generating, by the server, a video depicting the action sequence running on the native interactive content application; generating, by the server, a website comprising a browser-based application configured to allow replaying at least a portion of the action sequence on a browser-based version of the interactive content application; and sending to a second user device, before or after the website is generate, a URL associated with the website.

It is contemplated that the video can be a looping video, with or without sound. In some embodiments, the looping video is compressed. In some embodiments, the step of sending the URL to the second user device is accomplished by sending the URL to an IP address associated with the second user device, while in other embodiments, the step of sending the URL to the second user device is accomplished by sending the URL to a phone number associated with the second user device.

One should appreciate that the disclosed subject matter provides many advantageous technical effects including the ability to use an app or game in a web browser, thereby circumventing platform restrictions. This innovation also facilitates the ability of game and app developers to increase their user bases.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart showing how a server responds to a message from a user device.

FIG. 2 shows a first user device sending a message to a server.

FIG. 3 shows the first user device receiving a response from the server.

FIG. 4 shows a second user device receiving a response from the server.

FIG. 5 shows a first user device sharing a response from the server with a second user device.

FIG. 6 shows a second user device running a game through a web browser on a dynamically generated website.

FIG. 7 is a flow chart showing how a second user device can behave when it receives a response from a server or a first user device.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

The present invention relates to sharing interactive content applications (e.g., games and apps that run on computing devices). Embodiments of the inventive subject matter can be implemented to generate an active user base for an interactive content application without requiring all those users to download the application to use it. This is accomplished by directing users to a dynamically generated website that allows the interactive content application to be used regardless of the operating system of the user device that is accessing the website or whether the application is installed natively on that user device.

In some embodiments, methods of the inventive subject matter allow a user to play a mobile game (also referred to more broadly as an interactive content application, as above) with another user without any platform restrictions. In some embodiments, the inventors contemplate that a first user can use a game to interact with a second user, for example, by sharing, asking for help, and challenging the second user without needing to consider whether the second user has the game installed on their own device, regardless of platform or operating system. It is also contemplated that methods of the inventive subject matter can be implemented for any type of interactive content application and should not be restricted to games. This application describes embodiments that relate to games for the convenience of explanation.

When a user wishes to share a game using methods of the inventive subject matter, a message is sent to a server from a first user device, and the server creates assets necessary for other users to access that content and then play the game remotely (e.g., via a web browser) from their own devices. It is contemplated that the message can include a video of the game being played as recorded on the device from which the message originates. In some embodiments, instead of a recorded video, information sufficient for a server to reconstruct a video of the game being played on the user device can be transmitted with the message. After a message is sent to a server, a response can be distributed to other users through several channels. In some embodiments, the response is received by a first user and shared to a second user. In other embodiments, a response is received directly by a second user after a message was initiated by a first user.

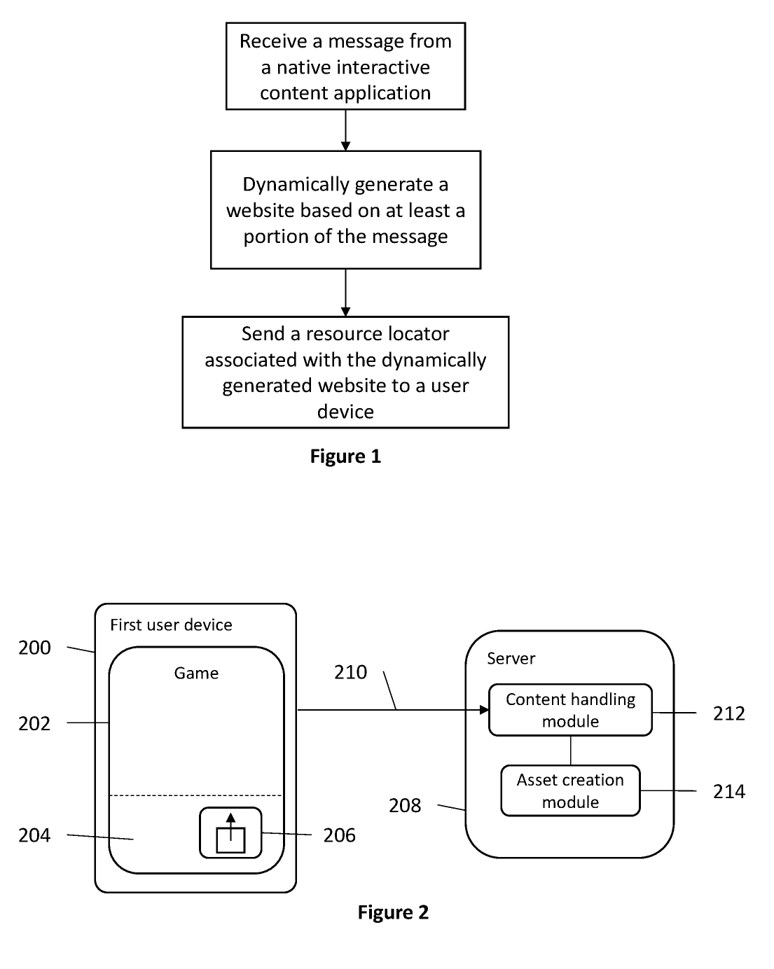

Responses can be delivered or shared through, for example, messaging applications, social networks, text message (MMS or SMS), or any other electronic message delivery system. Once other users have received a response, those other users can access the game by clicking on a link that is included with the response. FIG. 1 is a flow chart showing the steps of this process as described from the perspective of a server.

FIGS. 2-6 show steps of an embodiment of the inventive subject matter illustrated with user devices and server(s). FIG. 2 shows a first user device 200 running a game 202 natively on the first user device 200. Although FIGS. 2-6 focus on an implementation of this invention as applied to gaming, it is contemplated that the first user device 200 can be natively running any interactive content application (game or otherwise). When the person playing the game on the first user device 200 wants to share the game with, for example, a friend using a second user device, that person can bring up a sharing menu 204 in the game running natively on the first user device 200. It is contemplated that the sharing menu includes a share button 206 that, when pressed, initiates preparation and sending of a message to a server 208.

In some embodiment, some parameters of the message can be defined within the game itself. For example, if the user brings up the sharing menu by selecting “get help on this level” within a game menu, then the message will include that the first player on the first user device is seeking help on a level by a second player on a second user device.

A message 210 is sent to a server 208 from the first user device 200 as shown in FIG. 2. A message 210 includes a request for a resource locator (e.g., a URL) and, in some embodiments, a short video clip (a gameplay clip) of the game running on the first user device 200. The gameplay clip can be a video of the game being played natively on the first user device 200.

To create the gameplay clip, it is contemplated that the game can make a recording of a person playing the game on the first user device 200. In some embodiments, instead of sending a recorded video, the first user device 200 can instead record and send information sufficient to recreate gameplay in a video that is rendered remotely (e.g., on a server), thus reducing bandwidth requirements. For example, player movements, locations, actions, and interactions with the game world can be recorded by the first user device 200 and then sent to the server 208, and the server 208 can then recreate the player's actions by rendering a video of the player's movements, locations, actions, and interactions with the game world for distribution to other user devices. In some embodiments, the message from the first user device 200 includes both a video and information sufficient to recreate the video.

It is also contemplated that a message can additionally include a request to allow a person using a second user device to access only particular content within a game (e.g., user generated game content, access to a particular level, a demo version of the game, and access to a multiplayer session of the game with player on the first user device). It is also contemplated that the person using the second user device can be given full access to the game.

In some embodiments, a message is sent to a server before the game has been played enough to record a gameplay clip. In those cases, it is contemplated that a stock gameplay clip can be used instead of a recording of a player playing the game on the first user device 200. A stock gameplay clip can be stored locally on the first user device 200, or it can be stored remotely on the server 208.

As shown in FIG. 2, the content handling module 212 receives the message from the first user device 200. It is contemplated that the content handling module 212 can be responsible for receiving messages from a multitude of user devices. The content handling module 212 is configured to improve the server's ability to receive multiple messages, which can come in at the same time or in quick succession. For example, the content handling module 212 can quickly store messages to a computer readable medium for later access (e.g., a memory buffer), assigning each message an identifier to determine which order the content handling module 212 received the messages in.

After receiving the message 210 at the content handling module 212, the server 208 then uses its asset creation module 214 to create a response to the message. For example, the asset creation module 214 can use all or some of the gameplay clip, or the information sufficient to recreate a gameplay clip (as described above), to create a modified gameplay clip. A modified gameplay clip can include a text overlay advertising the game, or it can simply be a shortened version of the gameplay clip.

The asset creation module 214 can also compress or encode the modified gameplay clip into a format that is easy to share and view (e.g., *.gif, *.gifv, or any other video format, looping or non-looping). In some embodiments, the modified gameplay clip takes up less space than the original gameplay clip either by compression, by trimming the clip, or both. It is contemplated that the modified gameplay clip can be configured to automatically loop.

The asset creation module 214 is also configured to create a dynamically generated website based on at least a portion of the content of the message. In some embodiments, the dynamically generated website can be based on the video or information sufficient to recreate the video. For example, if a first player on a first user device is on a particular level and stuck at a particular spot, information about the players actions in the game can be used by the server to dynamically create a website that, when accessed by a second user device, allows a second player to assist the first user in getting past that spot.

The asset creation module 214 is also responsible for generating a URL (e.g., a type of resource locator) in response to the message from the first user device 200, where the URL directs a web browser to the dynamically generated website that is created based on information in the message as described above. The dynamically generated website can be created any time after the message is first received by the server, and it can even be created “on demand” at the time the website is first visited by a user device navigating its web browser to the URL. The dynamically generated website allows a second person using a second user device to play the game from which the message was originally generated by the first user device 200.

It is contemplated that the asset creation module 214 can also create responses that include content responsive to all or part of the message 210 to allow another user to access certain content within a game (e.g., user generated game content, access to a particular level, and information sufficient to facilitate a multiplayer session of the game with another user). The response must at least include a resource locator such as a URL.

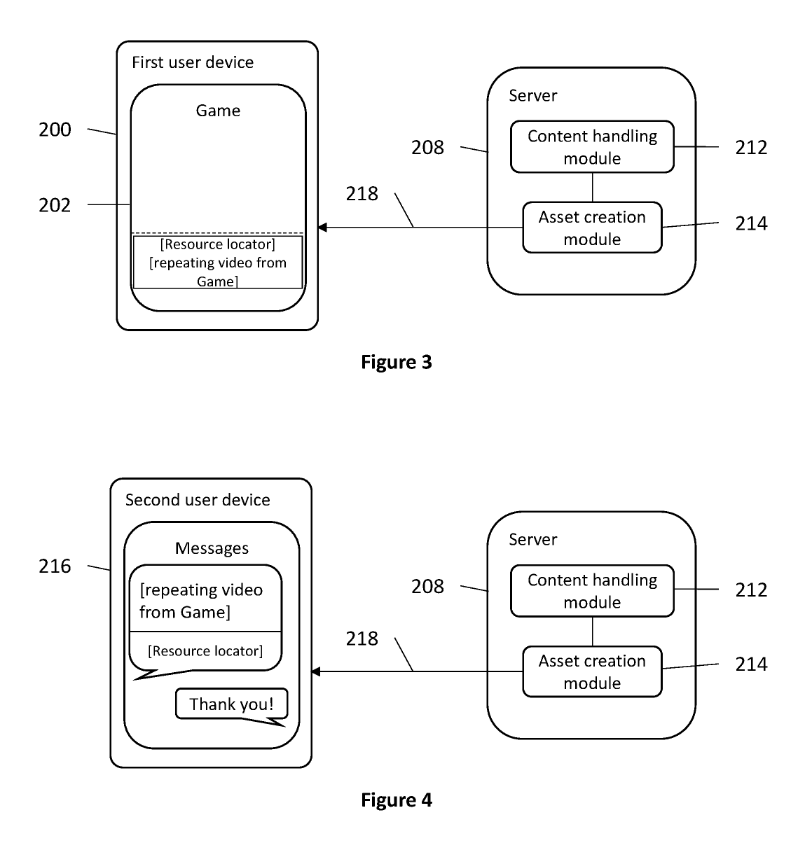

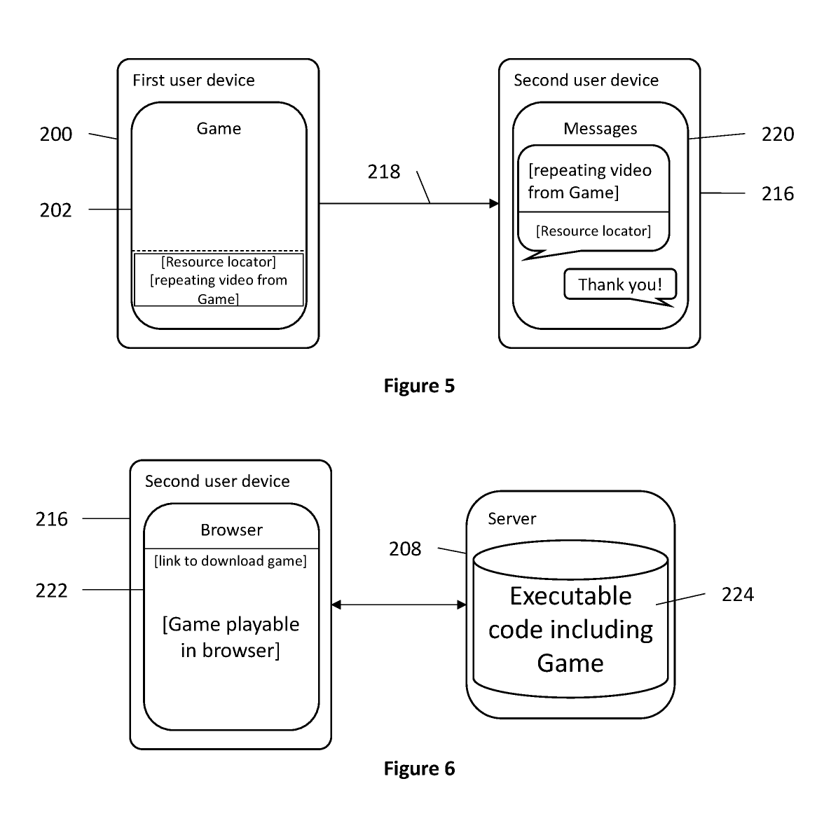

In some embodiments, as shown in FIG. 3, the response 218 (e.g., a URL along with a looping gameplay clip) is sent from the server's asset creation module 214 to the first user device 200. The first user device 200 can then share all, or a portion of, the response 218 to a second user device 216 as shown in FIG. 5.

It is also contemplated that the message 210 from the first user device 200 can include a response destination (e.g., a phone number, an IP address, a MAC address, an email address, a username, or another device identifier). The asset creation module 214 can then distribute the response 218 (or a portion thereof) directly to a second user device 216 using the response destination, as shown in FIG. 4, instead of sending the response 218 (or a portion thereof) to the first user device 200 and then requiring the first user device 200 to choose where to send the response 200.

In embodiments where the response 218 is sent to the first user device 200, the person using the first user device 200 must then manually determine where to send the response 218 (e.g., they must share it with a friend via text message, Facebook message, or any other form of digital messaging). FIG. 5 shows a first user device 200 sending a response 218 comprising a looping gameplay clip and a URL to a second user device 216 via a messaging service.

Within the messaging app 220, as shown in FIG. 5, the second user device 216 shows the looping gameplay clip and the URL. The second user device 216 can then access the URL using a web browser 222, as shown in FIG. 6. Upon accessing the URL, a web browser running on the second user device 216 navigates to the dynamically generated website that allows the second player to play the game through the web browser 222. The dynamically generated website is created by running executable code 224 that is stored on a server 208. The executable code 224 on the server 208 includes the game code as well as code sufficient to dynamically generate a website according to parameters and information conveyed by the message 210 that is delivered to the server 208 from the first user device 200.

The executable code 224 can also include additional code to determine, for example, what platform the second user device 216 is using (e.g., iOS or Android). It is contemplated that the server storing executable code can be the same as the server that stores the content handling module 212 and the asset creation module 214, but this is not a requirement. The modules 212 & 214 and executable code 224 can be stored on any number of servers, either entirely or in part, and the term “server” can refer to a cloud of servers or any number of servers that operate together to run stored executable code.

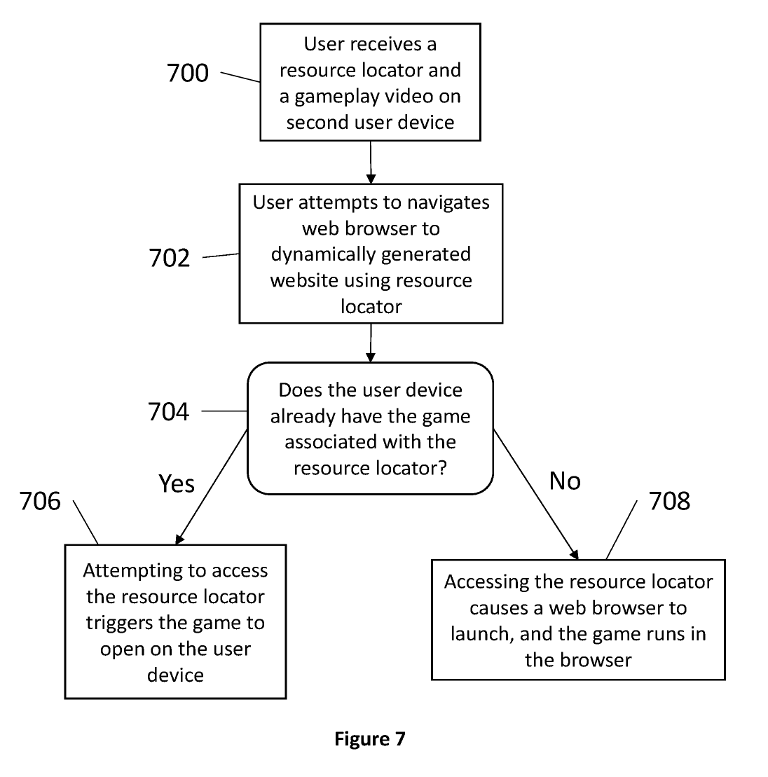

FIG. 7 is a flow chart showing how a second user device can handle receipt of a response, which is received from either a first user device or directly from a server. First, as shown in step 700, the second user device receives a resource locator and a gameplay video from another user device or from a server. When the second user device opens the resource locator using a web browser, as shown in step 702, there are two possible outcomes, as determined in step 704.

In a first outcome a shown in step 706, if the second user device already has the game corresponding to the response natively installed, then an attempt to open the resource locator will trigger a call to launch (e.g., be awoken, launched, or an equivalent) the natively installed game on the second user device as shown in step 706. The game can then operate according to information contained within the response (e.g., the user is granted access to a level in a game or to user generated content, or the user is able to play a multiplayer session with the person that sent the initial message corresponding to the received response). It is contemplated that the URL itself can define what content may be accessed by the device that clicks on the URL.

As shown in step 708, if a person using the second user device attempts to open the resource locator without having the game natively installed, then an attempt to open the resource locator results in a session of the game being run at the dynamically generated website that the resource locator directs a web browser to. This grants the second user device access to the game without needing to locally download and install the game. In some embodiments, a link can be displayed on the dynamically generated website that, went clicked, directs the user to download a local copy of the game native to their operating system.

Methods of the inventive subject matter can be used with games, as described above, or with any other type of interactive content application. Implementing the method for games facilitates cross-platform gaming between a native game and a browser instance of the same game. In some embodiments, the method includes an operation that enables a native mobile gamer (e.g., where a copy of the game is installed natively on a user device) to share a game experience with another user (e.g., invite another user to play the same game) or with multiple users through any social platform and/or messaging platform.

Users that receive a response will be able to play the game in a web browser without having to download the game locally. In some embodiments, users can have a connected experience with the user who sent the response to them (e.g., the two users can play cooperatively). It is contemplated that there can be a connection between the web browser game experience and the natively installed game experience (e.g., cooperative play).

The same can be true for other types of applications. For example, a user can use their device to message to collaborate on a document with a second user. That message would be processed by a server's content handling module and asset creation module to develop a response that includes a URL that directs the second user's device to a website that allows the second user to collaborate on the document with the user that initiated the message.

In the context of a game, for example, a first user could be playing the game, and if the first user cannot figure out how to progress in the game (e.g., the first user cannot figure out a word, image, puzzle, etc.), that user can solicit help from a friend or a group of friends by sending a message to a server, where the message includes a request for a URL, a gameplay clip showing where the player is stuck, and content sufficient to allow other users to connect to the first user's game session via a dynamically generated website. The server would then generate a response that can be sent directly to other users, or to the first user to distribute manually, so that recipients of the response can then help the first user with the game by playing cooperatively with the first user using a version of the game running on the dynamically generated website. In some embodiments, the first user can share his progress with one or more friends.

To bring other people into a gaming experience, the first user can, for example, invite friends to play the game with them. A response can include an “invitation” and can be distributed through, for example, a social media platform or a messaging platform like Facebook, Twitter, WhatsApp, SMS, etc. The persons that the first user invites can, for example, play the shared level in a web browser, and then, when they complete the level, the first user could then be notified that his friends were able to complete the level. These notifications can be delivered through the game itself. In some embodiments, the first user could then be given hints or tips to help them complete that level. After the first user's friends have played the level, the friends would be prompted to download the app to keep playing.

It is contemplated that, in some embodiments, once a second user receives a response on their device and then clicks the URL, the first user (e.g., the user that generated the content and shared the link) will then be notified that the second user has navigated to the dynamically generated website via the URL (e.g., clicked the link). Once the second user has accessed the dynamically generated website, they can be prompted to download a native version of the application to their mobile device. In some embodiments, although the second user could use the dynamically generated website indefinitely, the second user will not have access to the full set of features associated with the application running on the dynamically generated website unless they download and natively install the application. In some embodiments, after downloading the application to a mobile device, a user can then share their own content with, for example, a link as described above.

Thus, specific compositions and methods of circumventing platform restrictions have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A computer-implemented method of enabling multiplatform interactive content access, comprising the steps of:
receiving, by a server, a message from a native interactive content application running on a first user device, wherein the message comprises: (1) a first video of the native interactive content application running on the first user device capturing an action sequence defined by a first user engaging with the interactive content application, and (2) data associated with the action sequence;
generating, by the server, a second video comprising at least a portion of the first video;
dynamically generating a website, based at least in part on the data associated with the action sequence, wherein the website comprises the second video and enables a second user to engage, through a web browser on a second user device, at least a portion of the action sequence defined by the first user; and
sending to the first user device, before or after dynamically generating the website, (1) the second video and (2) a resource locator associated with the website.

2. The method of claim 1, wherein the second video is a looping video.

3. The method of claim 2, wherein the looping video does not include audio.

4. The method of claim 2, wherein the looping video is compressed.

5. The method of claim 1, further comprising:
determining, by the server, an operating system of the second user device;
sending a resource locator associated with an installer for the native interactive content application corresponding to the operating system of the second user device.

6. A computer-implemented method of enabling multiplatform interactive content access, comprising the steps of:
sending to a server, by a first user device, a message from a native interactive content application running on the first user device, the message comprising: (1) a first video of the native interactive content application running on the first user device capturing an action sequence defined by a first user engaging with the interactive content application, and (2) first data associated with the action sequence;
receiving a response comprising a resource locator associated with a dynamically generated website, wherein the dynamically generated website displays the first video and enables re-engaging at least a portion of the action sequence defined by the first user through a web-browser-based application; and
sending the response to a second user device.

7. The method of claim 6, wherein the first video is a looping video.

8. The method of claim 7, wherein the looping video does not include audio.

9. The method of claim 7, wherein the looping video is compressed.

10. The method of claim 6, further comprising sending to the second user device, with the response, a second video corresponding to at least a portion of the first video.

11. The method of claim 6, wherein, when the second user device opens the resource locator with a web browser, the dynamically generated website displays a link to download an installer for the native interactive content application corresponding to an operating system of the second user device.

12. A computer-implemented method of enabling multiplatform interactive content access, comprising the steps of:
receiving, by a server, a message from a native interactive content application running on a first user device, wherein the message comprises an action sequence associated with the native interactive content application;
generating, by the server, a video depicting the action sequence running on the native interactive content application;
generating, by the server, a website comprising a browser-based application configured to allow replaying at least a portion of the action sequence on a browser-based version of the interactive content application; and
sending to a second user device, before or after the website is generate, a URL associated with the website.

13. The method of claim 12, wherein the video is a looping video.

14. The method of claim 13, wherein the looping video does not include audio.

15. The method of claim 13, wherein the looping video is compressed.

16. The method of claim 12, wherein the step of sending the URL to the second user device is accomplished by sending the URL to an IP address associated with the second user device.

17. The method of claim 12, wherein the step of sending the URL to the second user device is accomplished by sending the URL to a phone number associated with the second user device.
